(19) United States
(12) Patent Application Publication
(10) Pub. No.: US 2026/0012978 A1
(43) Pub. Date: Jan. 8, 2026

(54) TXOP ADJUSTMENT FOR WIRELESS NETWORK

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/239,768

(22) Filed: Jun. 16, 2025

Related U.S. Application Data
(60) Provisional application No. 63/668,716, filed on Jul. 8, 2024.

(51) Int. Cl. H04W 74/0816; H04W 28/02; H04W 76/15

(52) U.S. Cl. CPC H04W 74/0816; H04W 28/0268; H04W 76/15

(57) ABSTRACT

A station (STA) in a wireless network is described. The STA includes a memory and a processor coupled to the memory, the processor is to cause transmitting, to an access point (AP), a request frame that indicates a request to reduce a transmission opportunity (TXOP) duration and receiving, from the AP, a response frame that indicates acceptance of the request to reduce the TXOP duration. The processor is further to cause receiving, from the AP, a frame indicating a reduced TXOP duration, and transmitting, to the AP, one or more frames based on the reduced TXOP duration.

### CROSS-REFERENCE TO RELATED APPLICATION(S)

This application claims the benefit of priority from U.S. Provisional Application No. 63/668,716, entitled “TXOP LIMIT ADJUSTMENT FOR LOW LATENCY SUPPORT IN NEXT GENERATION WLANS,” filed Jul. 8, 2024, which is incorporated herein by reference in its entirety.

### TECHNICAL FIELD

This disclosure relates generally to a wireless communication system, and more particularly to, for example, but not limited to, adjusting a transmission opportunity (TXOP) for wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

Examples of extremely low latency application can include real-time gaming, cloud gaming, real-time video, and for robotics and industrial automation. In some examples, depending on the low latency traffic and an access category (AC) associated with the low latency traffic, there can be a large TXOP assigned for the AC to increase throughput of the low latency traffic. For example, to meet voice and video requirements of the 802.11 standards, support for quality of service (QoS) traffic was adopted to provide differentiated channel access to frames belonging to different priorities. In the context of video and voice, there can be eight different user priorities and four different access categories, and there can be a different TXOP limit assigned for a priority or access category.

However, when a packet arrives at a STA, the packet can face uplink channel access delay due to transmissions that occupy the channel. That is, the STA can defer to transmissions from other STAs or the AP. In examples where there are large TXOP, the STA can continuously defer causing significant delay or an expiration of an opportunity to transmit the packet. Additionally, the AP can be unaware of when a packet arrives at the STA and therefore can struggle to change the TXOP interval to accommodate the STA. Accordingly, a procedure for adjusting the TXOP interval is needed.

The description set forth in the background section should not be assumed to be prior art merely because it is set forth in the background section. The background section may describe aspects or embodiments of the present disclosure.

### SUMMARY

An aspect of the present disclosure provides for a station (STA) in a wireless network including a memory and a processor coupled to the memory, the processor to cause transmitting, to an access point (AP), a request frame that indicates a request to reduce a transmission opportunity (TXOP) duration, receiving, from the AP, a response frame that indicates acceptance of the request to reduce the TXOP duration, receiving, from the AP, a frame indicating a reduced TXOP duration, and transmitting, to the AP, one or more frames based on the reduced TXOP duration.

In an embodiment, the request frame includes an indication of a type of traffic associated with the reduced TXOP duration.

In an embodiment, the request frame indicates an amount by which the TXOP duration is to be reduced.

In an embodiment, the request frame indicates a time period during which the TXOP duration is to be reduced.

In an embodiment, the frame indicating the reduced TXOP duration includes enhanced distribution channel access (EDCA) parameters associated with the reduced TXOP duration.

In an embodiment, the STA is affiliated with a non-AP STA multi-link device (MLD) comprising a plurality of STAs, the request frame is transmitted over a first link established between the STA affiliated with the non-AP MLD and the AP affiliated with an AP MLD, and the request frame indicates a request to reduce the TXOP duration on a second link established between another STA affiliated with the non-AP MLD and another AP affiliated with the AP MLD.

In an embodiment, the request frame indicates the second link on which the TXOP duration is to be reduced.

In an embodiment, the processor is further to cause receiving, from the AP, a second frame indicating that the AP supports a reduction of TXOP duration.

An aspect of the present disclosure provides for an access point (AP) in a wireless network including a memory and a processor coupled to the memory, the processor to cause receiving, from a station (STA), a request frame that indicates a request to reduce a transmission opportunity (TXOP) duration, transmitting, to the STA, a response frame that indicates acceptance of the request to reduce the TXOP duration, transmitting, to the STA, a frame indicating a reduced TXOP duration, receiving, from the STA, one or more frames based on the reduced TXOP duration.

In an embodiment, the processor is further cause receiving, from the STA, a quality of service (QoS) characteristic element during a stream classification service (SCS), determining a channel access duration of the STA fails to satisfy a channel delay associated with the STA, and transmitting, to the STA, a second frame indicating a second reduced TXOP duration responsive to determining the channel access duration of the STA fails to satisfy the channel delay.

In an embodiment, the request frame includes an indication of a type of traffic associated with the reduced TXOP.

In an embodiment, the processor is to further cause transmitting, to one or more STA associated with AP, a second frame indicating the reduced TXOP.

In an embodiment, the processor is to further cause transmitting, to a set of one or more STA associated with AP, a second frame indicating the reduced TXOP.

In an embodiment, the processor is further to cause transmitting, to the STA, a second frame indicating that the AP supports a reduction of TXOP duration.

In an embodiment, the AP is affiliated with an AP multi-link device (MLD) comprising a plurality of APs, the request frame is transmitted over a first link established between the AP affiliated with the AP MLD and the STA affiliated with a non-AP STA MLD, and the request frame indicates a request to reduce the TXOP duration on a second link established between another AP affiliated with the AP MLD and another STA affiliated with the non-AP STA MLD.

In an embodiment, the frame indicating the reduced TXOP duration includes enhanced distribution channel access (EDCA) parameters associated with the reduced TXOP duration.

An aspect of the present disclosure provides for a method performed by a station (STA) in a wireless network, including transmitting, to an access point (AP), a request frame that indicates a request to reduce a transmission opportunity (TXOP) duration, receiving, from the AP, a response frame that indicates acceptance of the request to reduce the TXOP duration, receiving, from the AP, a frame indicating a reduced TXOP duration, and transmitting, to the AP, one or more frames based on the reduced TXOP duration.

In an embodiment, the request frame includes an indication of a type of traffic associated with the reduced TXOP duration.

In an embodiment, the request frame indicates an amount by which the TXOP duration is to be reduced.

In an embodiment, the request frame indicates a time period during which the TXOP duration is to be reduced.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example access category queue in accordance with an embodiment.

FIG. 5 shows an example uplink channel access in accordance with an embodiment.

FIGS. 6A and 6B shows example uplink channel accesses in accordance with an embodiment.

FIG. 7 shows an example TXOP reduction request in accordance with an embodiment.

FIG. 8 shows an example process for TXOP reduction in accordance with an embodiment.

FIG. 9 shows an example TXOP reduction reception in accordance with an embodiment.

FIG. 10 shows an example process for TXOP reduction in accordance with an embodiment.

FIG. 11 shows an example process for TXOP reduction for QoS in accordance with an embodiment.

FIG. 12 shows an example process for a TXOP reduction in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

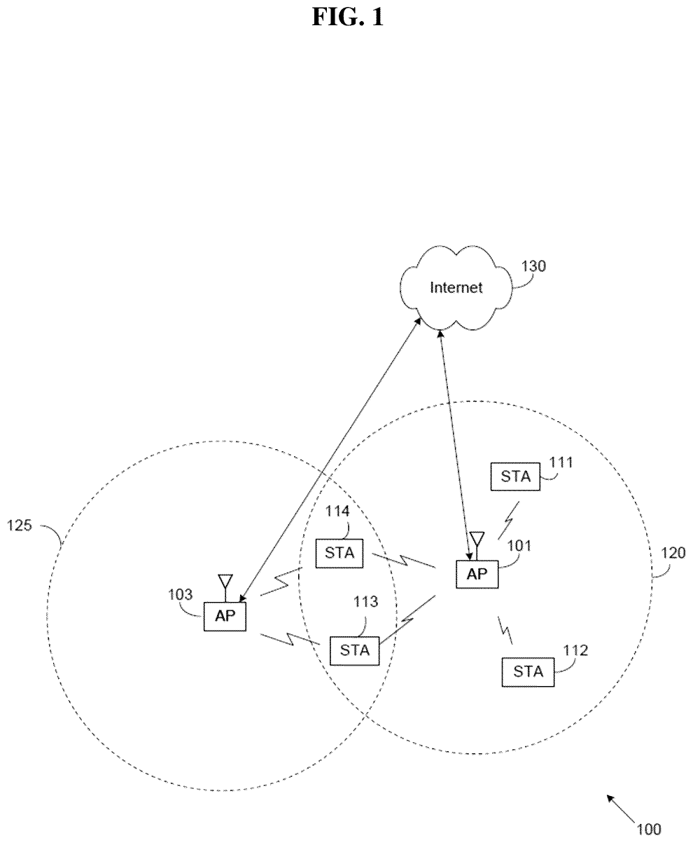

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

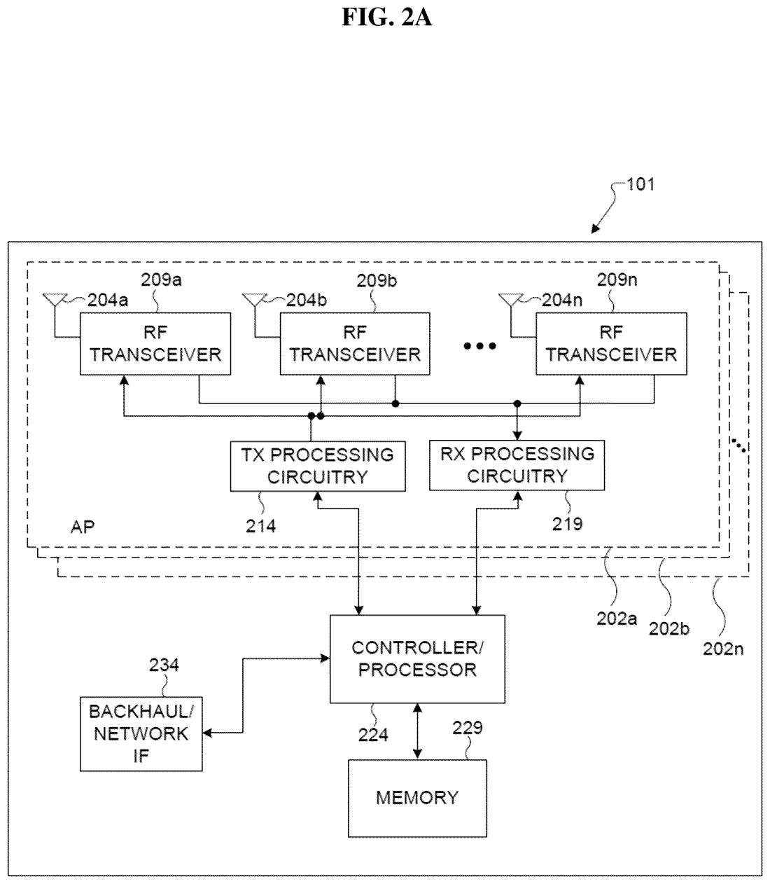

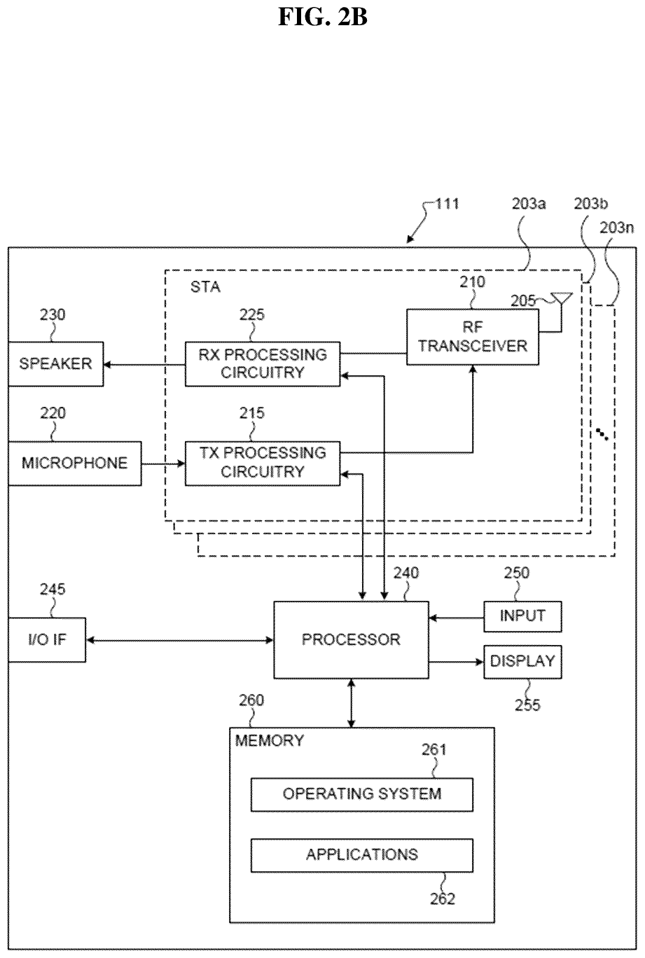

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

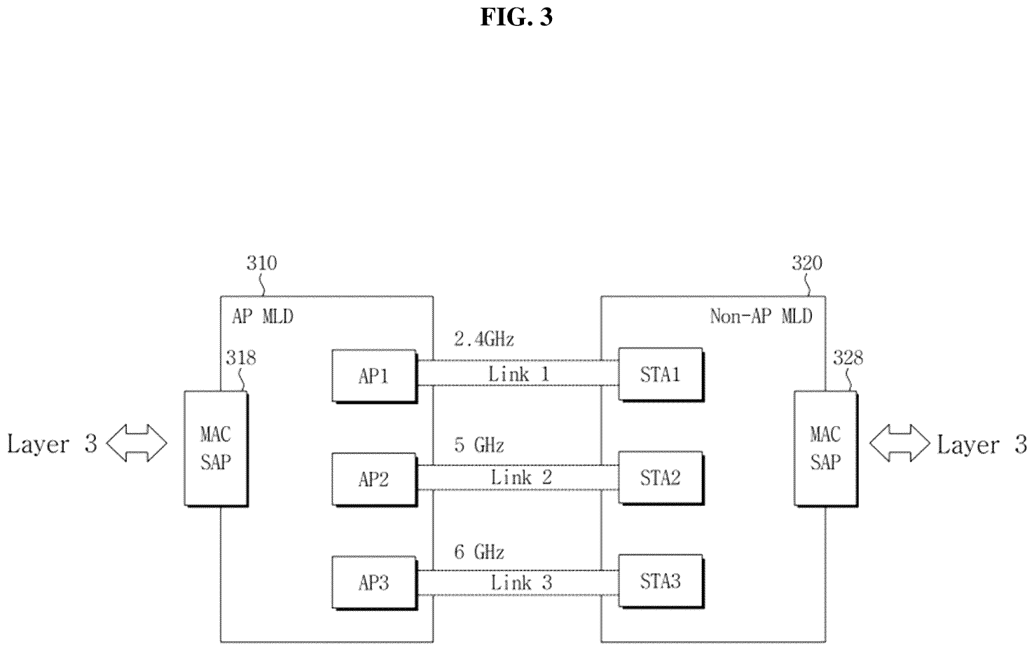

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11be D5.0, “Wireless LAN Medium Access Control (MAC) and Physical Layer (PHY) Specifications,” ii) IEEE Std 802.11-2020, “Wireless LAN Medium Access Control (MAC) and Physical Layer (PHY) Specifications,” and iii) IEEE std 802.11ax-2021, “Wireless LAN Medium Access Control (MAC) and Physical Layer (PHY) Specifications.”

In some embodiments, an ultra-high reliability (UHR) study group (UHR SG) is a group that designs and studies a next generation Wi-Fi standard (IEEE 802.11bn). The UHR SG has set a number of objectives for the next generation Wi-FI network design. In one embodiment, the UHR SG has set an objective to achieve a UHR target by reducing latencies to ultra-low values, increasing throughputs at different signal-to-noise ratio (SNR) levels, enhancing power savings etc. In at least one embodiment, the UHR SG intends to develop new protocols and concepts for improving performance compared to Wi-Fi 7 and meeting the objectives.

In some examples, there are new applications for which the UHR SG is considering to provide support for the next generation Wi-Fi networks. In one embodiment, the following table (Table 1) illustrates possible applications with low latency requirements:

TABLE 1

| | | Intra | | | |
|---|---|---|---|---|---|
| | | Basic | | | |
| | | Service | | | |
| | | Set | | | |
| | | (BSS) | | | |
| | | latency | | | Data rate |
| | | (milli- | | | (megabits |
| | | seconds | Jitter | Packet | per second |
| Application | | (ms)) | Variance | Loss | (Mbps) |
| Real-time Gaming | | <5 | <2 | <0.1% | <1 |
| Cloud Gaming | | <10 | <2 | Near- | <0.1 |
| | | | | loseless | (Reverse |
| | | | | | link) |
| | | | | | >5 mbps |
| | | | | | (Forward |
| | | | | | link) |
| Real-time Video | | <3~10 | <1~2.5 | Near- | 100~28,000 |
| | | | | loseless | |
| Robotics | Equipment | <1~10 | <0.2~2 | Near- | <1 |
| and | Control | | | loseless | |
| industrial | Human | <1~10 | <0.2~2 | Near- | <1 |
| automa- | Safety | | | loseless | |
| tion | Haptic | <1~15 | <0.2~2 | Lossless | <1 |
| | Technol- | | | | |
| | ogy | | | | |
| | Drone | <100 | <10 | Loseless | <1 |
| | Control | | | | >100 with |
| | | | | | video |

In one embodiment, Table 1 illustrates, for each application category, a requirement in terms of intra-basic service set (BSS) latency (e.g., a time to transmit a frame from an access point (AP) to a station (STA) or vice versa) (e.g., in milliseconds (ms)), a jitter variance (e.g., in ms), a packet loss, or data rate (e.g., in megabits per second). For example, a real-time gaming application can have an intra BSS latency requirement of less than 5 ms, a jitter variance requirement of less than 2 ms, a packet loss requirement of less than 0.1%, and a data rate requirement of less than 1 Mbps.

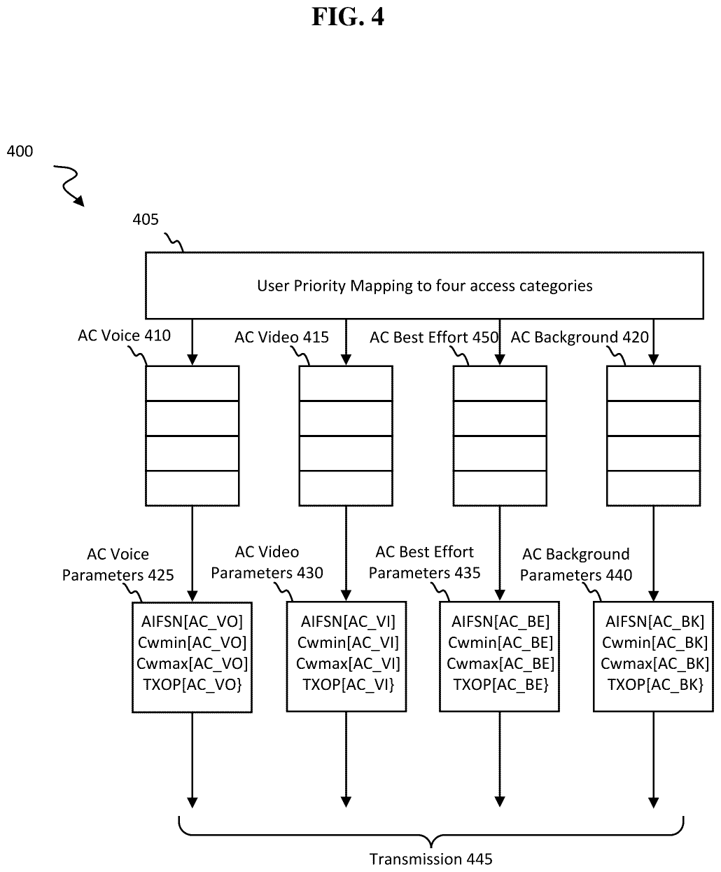

FIG. 4 illustrates an access category (AC) queue 400 in accordance with an embodiment herein. In at least one embodiment, the AC queue 400 illustrates a user priority mapping 405 to four AC which are transmitted at 445.

In some embodiments, support for quality of service (QoS) traffic was introduced to meet voice and video requirements over 802.11 WLAN (e.g., support introduced in 802.11e and adopted in later standards). In at least one embodiment, the support for QoS traffic provides differential channel access to frames belonging to different priorities. For example, there can be eight different user priorities, and four AC derived from the user priorities for traffic stream prioritization. In at least one embodiment, the four AC supported are voice (e.g., AC voice 410), video (e.g., AC video 415), best effort (e.g., AC best effort 450), and background (e.g., AC background 420). In at least one embodiment, AC voice 410, AC video 415, AC best effort 450, and AC background 420 can be referred to as AC_VO, AC_VI, AC_BE, AC_BK respectively. In one embodiment, a first user priority and a second user priority are mapped to AC background 420 (e.g., user priority 1 and 2), a zeroth user priority and a third user priority are mapped to AC best effort 450 (e.g., user priority 0 and 3), a fourth user priority and a fifth user priority are mapped to AC video 415 (e.g., user priority 4 and 5), a sixth user priority and a seventh user priority are mapped to AC voice 410. In at least one embodiment, each AC has its own individual transmission queue, where the transmission queue behaves as an individual contending entity characterized by its own enhanced distributed channel access (EDCA) parameter set. For example, the AC voice 410 is associated with AC voice parameters 425, AC video 415 is associated with AC video parameters 430, AC best effort 450 is associated with AC best effort parameters 435, and AC background 420 are associated with AC background parameters 440, where the parameters are examples of EDCA parameter sets for each respective AC. In at least one embodiment, each parameters set (e.g., AC voice parameters 425, AC video parameters 430, AC best effort parameters 435, and AC background parameters 440) specifies a minimum and maximum value for a contention window (CW) (e.g., CWₘᵢₙ and CWₘₐₓ), an arbitration inter-frame spacing (AIFSN) value, and a transmission opportunity (TXOP) limit. In at least one embodiment, the AC queue 400 illustrates each AC category being transmitted with the associated parameters—e.g., AC voice 410 is transmitted at 445 based on the AC voice parameters 425, AC video 415 is transmitted at 445 based on the AC video parameters 430, etc.).

In some embodiments, when a particular AC completes its backoff and gains channel access, an STA can perform data transmission for an amount of time that is upper bounded by the TXOP limit indicated. In at least one embodiment, there can be different TXOP values for different AC based on their priority or type of AC. Examples of possible EDCA parameters for each AC is illustrated with reference to Table 2. As an example, a larger TXOP value can increase throughput. For example, a larger TXOP value can be provided for AC video 415 (e.g., in a majority of cases as illustrated in Table 2) to increase the throughput of high priority data such as the video data. Examples of the values are provided in the following table (Table 2):

TABLE 2

| | | | | TXOP Limit | | | | |
|---|---|---|---|---|---|---|---|---|
| | | | | | For PHY'S | | | |
| | | | | For PHY's | defined | | For PHY'S | |
| | | | | defined | in Clause | For PHY's | defined | For |
| Access | | | | in Clause | 17, 18, | defined in | in Clause | other |
| Category | CWₘᵢₙ | CWₘₐₓ | AIFSN | 15 and 16 | 19, and 21 | Clause 22 | 23 | PHY'S |
| AC | aCWₘᵢₙ | aCWₘₐₓ | 7 | 3.264 ms | 2.528 ms | 0 | 15.008 ms | 0 |
| Background | | | | | | | | |
| 420 | | | | | | | | |
| AC Best | aCWₘᵢₙ | aCWₘₐₓ | 3 | 3.264 ms | 2.528 ms | 0 | 15.008 ms | 0 |
| Effort 450 | | | | | | | | |
| AC Video 415 | $\frac{( {aCW}_{min} + 1 )}{2 - 1}$ | aCWₘᵢₙ | 2 | 6.016 ms | 4.096 ms | 22.56 ms (Basic | 15.008 ms | 0 |
| | | | | | | Channel | | |
| | | | | | | Unit | | |
| | | | | | | (BCU): 6 or 7 | | |
| | | | | | | megahertz | | |
| | | | | | | (MHz), | | |
| | | | | | | 16.92 ms | | |
| | | | | | | (BCU: 8 MHz) | | |
| AC Voice 410 | $\frac{( {aCW}_{min} + 1 )}{4 - 1}$ | $\frac{( {aCW}_{min} + 1 )}{2 - 1}$ | 2 | 3.264 ms | 2.080 ms | 11.28 ms (BCU: 6 or 7 | 15.008 ms | 0 |
| | | | | | | (MHz), | | |
| | | | | | | 8.46 ms | | |
| | | | | | | (BCU: 8 MHz) | | |

That is, Table 2 illustrates that a TXOP limit can vary based on an AC or a physical layer (PHY) version of the transmitting device (e.g., the PHY of the STA). In at least one embodiment, Table 2 illustrates EDCA parameter set element values for different AC in accordance with the 802.11 family of standards. As an example, other than PHY's defined in clause 23, each AC has a different TXOP value. In some embodiments, for PHY's defined in clause 23 (e.g., from the 802.11ac standard and adopted in subsequent standards), the values can be the same. In other embodiments, for PHY's defined in 212 (e.g., or 17, 18, 19, and 21) can assign a value of 2.528 ms for the TXOP limit for AC background 420 and AC best effort 450, 2.080 ms for AC voice 410, and 4.096 ms for AC video. In at least one embodiment, to support higher throughput for video data, AC Video 415 can be assigned a much higher value for the TXOP limit. Accordingly, an STA can that obtains channel access for the AC can transmit as many aggregated frames as possible while still remaining within the TXOP limit provided. In at least one embodiment, support for QoS traffic has been adopted in subsequent standards.

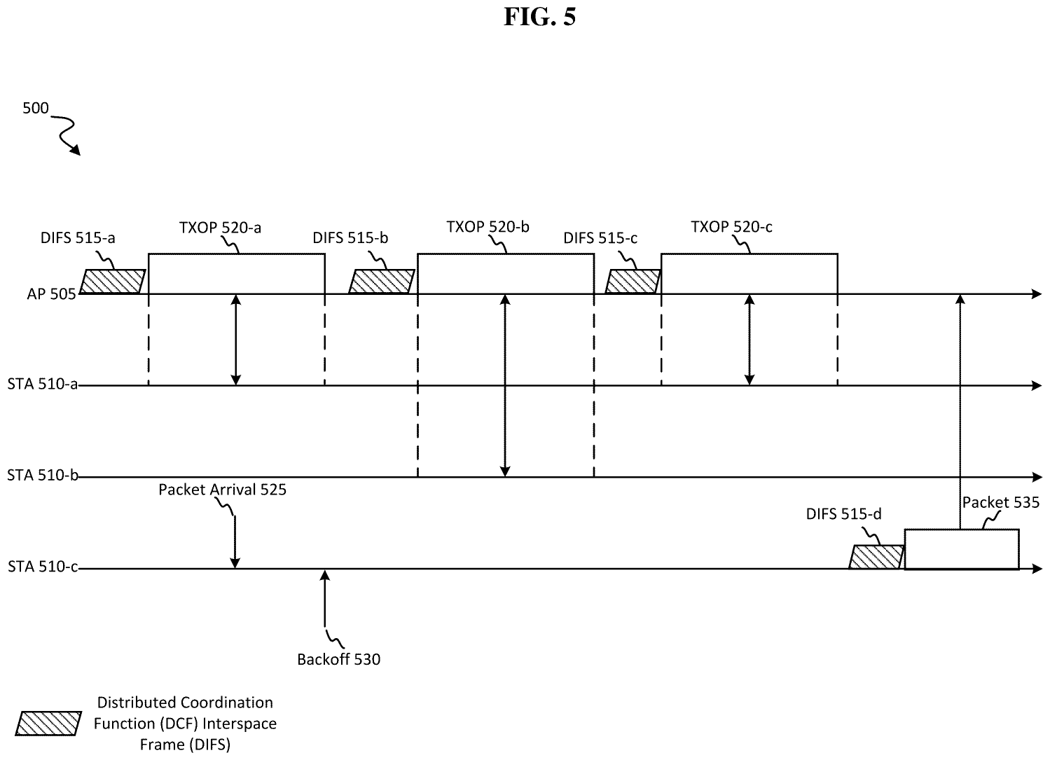

Referring to FIG. 5, uplink (UL) channel access 500 can illustrate a delay experienced by an STA as a result of a large TXOP. In one embodiment, uplink channel access 500 can illustrate an uplink channel access for an AP 505 (e.g., an example of AP 101 or AP 103 as described with reference to FIG. 1) and one or more associated stations (STAs) 510 (e.g., an example of STA 111, STA 112, STA 113, or STA 114 as described with reference to FIG. 1). In one embodiment, uplink channel access 500 can illustrate a channel access for a first STA 510-a, a second STA 510-b, and a third STA 510-c. Although one or more operations are described or shown in a particular sequential order, in other embodiments the operations may be rearranged in a different order, which may include performance of multiple operations in at least partially overlapping time periods.

In at least one embodiment, an AP 505 can win a TXOP 520-a after a first distributed coordination function (DCF) interframe space (DIFS+) interval 515-a. In such embodiments, the AP 505 can exchange information with the first ST 510-a during the TXOP 520-a. In some embodiments, the DIFS interval 515 can vary. For example, DIFS 515-b can be 36 microseconds (μs), DIFS 515-c can be 27 μs and DIFS 515-d can be 27 μs. In at least one embodiment, a limit for the TXOP 520 is 5 ms. In other embodiments, the TXOP 520 has a different TXOP limit. In some embodiments, a TXOP limit for a respective TXOP 520 can vary from TXOP to TXOP—e.g., TXOP 520-a can have a different TXOP value than TXOP 520-b.

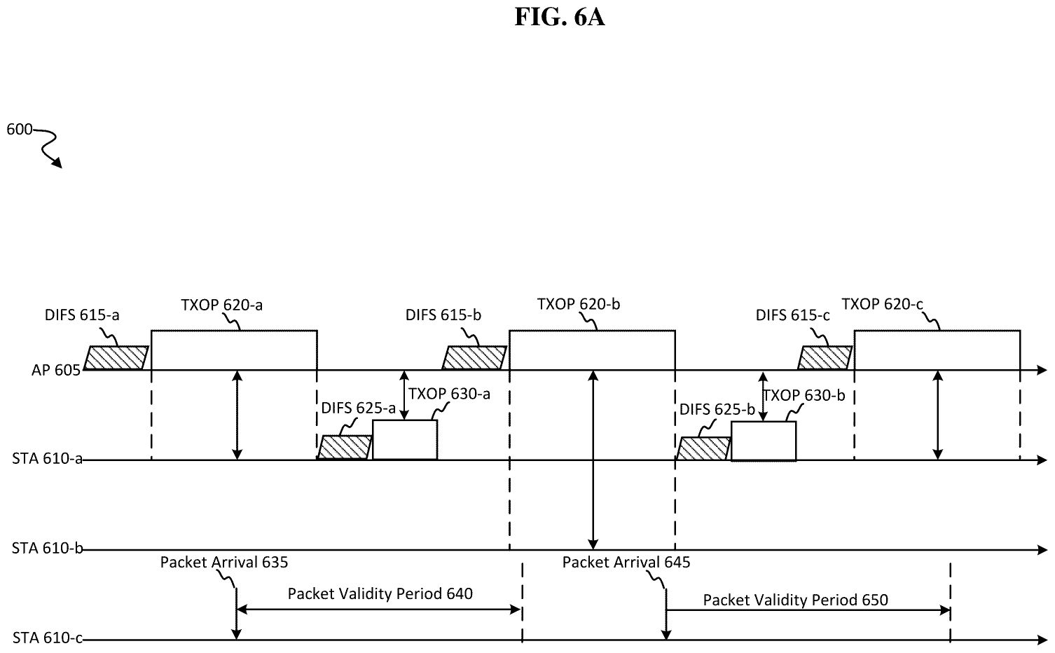

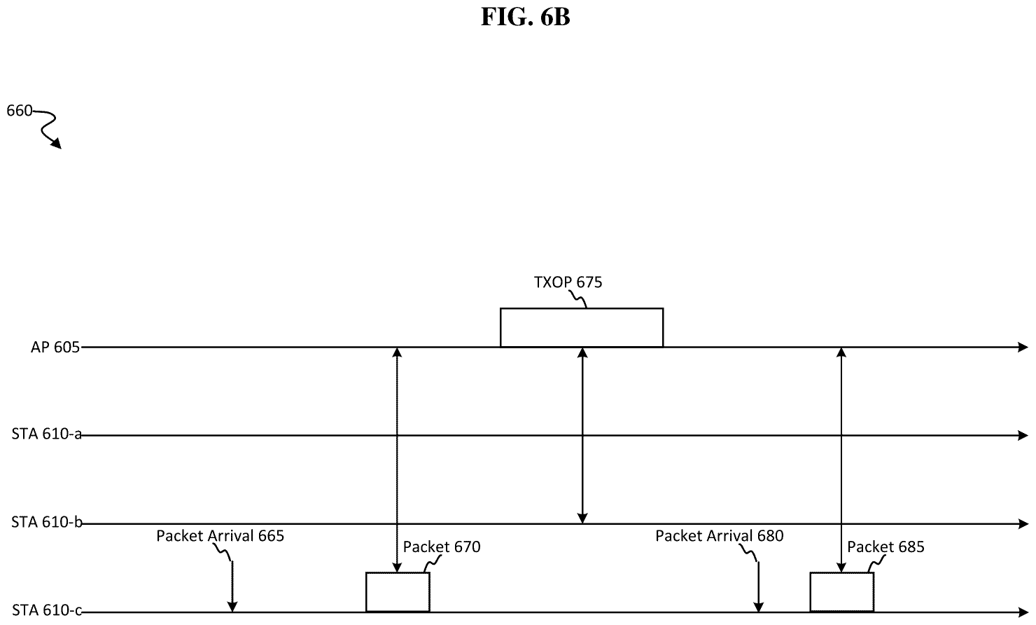

In one embodiment, while the AP 505 is transmitting during the TXOP 520-a, the third STA 510-c can receive a packet—e.g., packet arrival 525. In at least one embodiment, when the third STA 540-c receives the packet at packet arrival 525, the STA can face an uplink channel delay due to the TXOP 520-a occupying the channel before a backoff counter of the third STA 510-c goes to zero—e.g., before the third STA 510-c can win a contention based on the backoff 530 occurring while the channel is occupied by the AP 505. That is, the third STA 510-c can defer to transmissions from the AP 505 or the other STAs 510. In one embodiment, if a corresponding TXOP 520 is long (e.g., relatively long), the channel access uplink for the third STA 510-c can result in large delays and even cause packet expiration. For example, after receiving the packet at packet arrival 525, the third STA 510-c can defer transmission through TXOP 520-a, TXOP 520-b, and TCOP 520-c, before transmitting the packet 535 to the AP 505. In at least one embodiment, the STA 510-c can experience a delay due to a TXOP 520 limit utilized on a channel the STA 510-c is trying to access or contend for. In some examples, one possible solution is reduce a TXOP 520 limit to reduce the duration of the TXOP of a transmission the STA 510-c is referring to. For example, the AP could reduce the TXOP 520 limit value from 5 ms to try and reduce interference for the third STA 510. However, this can be infeasible as described with reference to FIG. 6.

Referring to FIGS. 6A and 6B, uplink (UL) channel access 600 and channel access 660 can illustrate a delay experienced by an STA and a difficulty in ascertaining how to adjust the TXOP limit. In one embodiment, uplink channel access 600 and channel access 660 can illustrate an uplink channel access for an AP 605 (e.g., an example of AP 101 or AP 103 as described with reference to FIG. 1) and one or more associated stations (STAs) 610 (e.g., an example of STA 111, STA 112, STA 113, or STA 114 as described with reference to FIG. 1). In one embodiment, uplink channel access 600 can illustrate a channel access for a first STA 610-a, a second STA 610-b, and a third STA 610-c. Although one or more operations are described or shown in a particular sequential order, in other embodiments the operations may be rearranged in a different order, which may include performance of multiple operations in at least partially overlapping time periods.

In at least one embodiment, an AP can be unaware of when a packet arrives at one of the STAs 610. For example, in some embodiments, the channel access procedure can be illustrated by uplink channel access 600 and in other embodiments, the channel access procedure can be illustrated by uplink channel access 600. In one embodiment, when illustrated by channel access 600 (e.g., referring to FIG. 6A), the third STA 610-c can receive a packet at packet arrival 635. In one embodiment, the packet can be associated with a packet validity period 640—e.g., a period in which the packet can be transmitted. In some embodiments, the third STA 610-c can refrain from transmitting a packet if the packet validity period 640 elapses. For example, while the third STA 610-c is receiving the packet, the AP 605 can be exchanging information with the first STA 610-a following a DIFS 615-a interval. In such embodiments, the third STA 610-c can defer its transmission of the packet based on the AP's TXOP 620-a. In one embodiment, as the third STA 610-c is deferring, the first STA 610-a can contend for channel access during DIFS 625-a and win a TXOP 630-a. Accordingly, the third STA 610-c can defer again. After the first STA 610-a wins the TXOP 630-a, the AP 605 can contend for channel access after the TXOP 630-a during DIFS 615-b to win TXOP 620-b. In such embodiments, the AP 605 can begin exchanging data with the second STA 610-b during the TXOP 620-b. In one embodiment, the third STA 610-C can defer transmitting the packet received at packet arrival 635 due to the AP 605 winning the TXOP 620-b. However, in such embodiments, the packet validity period 640 for the packet can elapse and the third STA 610-c can be unable to transmit the packet.

In one embodiment, the third STA 610-c can receive a second packet at packet arrival 645. In one embodiment, the third STA 610-c is also unable to transmit the second packet due to a long TXOP. That is, the third STA 610-c can receive the packet at packet arrival 645 while the AP is transmitting during TXOP 620-b. In one embodiment, the third STA 610-c can defer access, enabling the first STA 610-a to contend for the channel during DIFS 625-b and win a TXOP 630-b and the AP 605 to contend for the channel during DIFS 615-c and win TXOP 620-c. Accordingly, the packet validity period 650 can also elapse and the third STA 610-c can refrain from transmitting the packet.

However, although the large TXOP limit affected the third STA's 610-c transmission during uplink channel access 600, the large TXOP may not affect the third STA's 610-c transmission during uplink channel access 660. For example, referring to FIG. 6B, the third STA 610-c can receive a packet at packet arrival 665. In some embodiments, the packet received at packet arrival 665 can be a low latency packet (e.g., associated with one of the applications described with reference to Table 1). As illustrated in uplink channel access 660, the third STA 610-c can determine the channel is available and accordingly transmit the packet 670 to AP 605.

After transmitting the packet 670, sometime later, the AP 605 can win a TXOP 675 and exchange information with STA 610-b. After the TXOP 675, the third STA 610-c can receive a second packet 685 at packet arrival 680. The third STA 610-c can determine the channel is available and transmit the packet 685.

Accordingly, despite a longer TXOP utilized by the AP (e.g., a longer TXOP limit for TXOP 675), the third STA 610-c can transmit packets to the AP 605 without issue. In some embodiments, the uplink channel access 660 can illustrate low latency (LL) traffic that arrives with a long gap in between packet arrival—e.g., the packet 670 and packet 685 can be examples of voice traffic arriving with 10-15 ms inter-burst duration and the transmission by the AP 605 can occur between these inter-burst duration where the third STA 610-c is idle.

That is, FIGS. 6A and 6B illustrate that for non-deterministic traffic, it can be difficult to for the AP 605 to predict ahead of time if a long TXOP limit will affect an STA 610 transmission or not. In FIG. 6A the longer TXOP affected the third STA 610-c while in FIG. 6B the longer TXOP did not affect the third STA 610-c. Therefore, the AP 605 may not be able to determine whether to reduce a TXOP limit for providing support to low latency traffic.

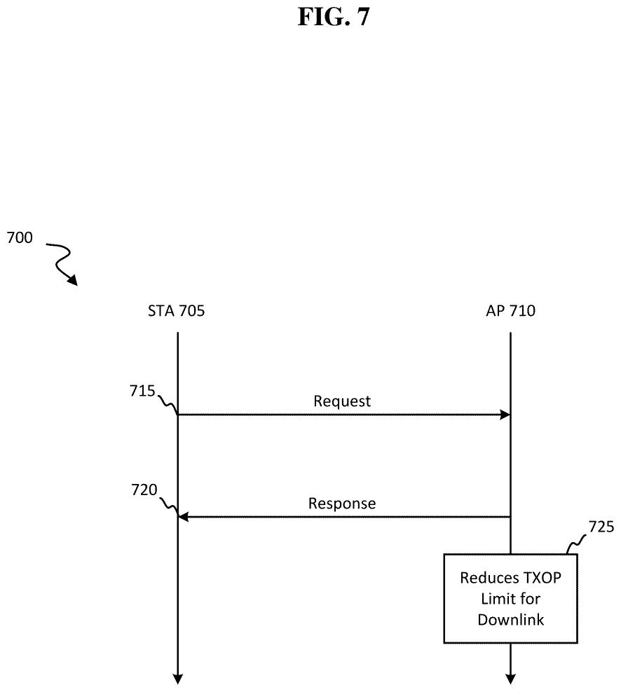

FIG. 7 shows an example transmission opportunity (TXOP) request process 700 in accordance with an embodiment. Although one or more operations are described or shown in a particular sequential order, in other embodiments the operations may be rearranged in a different order, which may include performance of multiple operations in at least partially overlapping time periods.

In at least one embodiment, process 700 is performed by a station (STA) 705 and an access point (AP) 710 (e.g., examples of STA 111, STA 112, STA 113, or STA 114 or AP 101 or AP 102 as described with reference to FIG. 1, respectively).

At operation 715, the STA 705 can transmit a request frame indicating a request to the AP 710 to reduce a TXOP limit (e.g., for an access category (AC)). That is, if the STA's low latency packets encounter a long defer delay due to large TXOP values, the STA transmits the request in operation 715. In at least one embodiment, the request frame can include at least one or more of the information items indicated in Table 3:

TABLE 3

| Information | |
|---|---|
| Item | Description |
| TXOP | One or more information items that indicate that the STA is |
| reduction | requesting to the AP to reduce the TXOP limit-e.g., can be |
| request | a bit or flag that represents the indication. In another |
| indication | embodiment, transmitting the request itself is an implicit |
| | method of making the request. |
| Traffic Type | One or more information items that indicate a type of |
| | traffic for which the co-existence constraint can apply to. |
| | For example, a traffic identifier (TID) bitmap can indicate |
| | the set of TIDs for which the TXOP limit request applies or |
| | the traffic type indicates an access category (AC) for the |
| | TXOP limit reduction. |
| Reduction | One or more information items that indicate an amount by |
| Duration | which the duration can be reduced or the new duration |
| | limit. |
| Reduction | One or more information items that can indicate the period |
| Period | for which the duration can be reduced-e.g., a number (e.g., |
| | remaining number) of target beacon transmission time |
| | (TBTT) from a current TBTT for which the duration can be |
| | reduced |

In at least one embodiment, the information items listed in Table 3 can be transmitted together or separately as part of request. In some embodiments, the information items listed in Table 3 can be included or transmitted as part of an existing IEEE 802.11 frame, element, field, or subfield. In other embodiments, the information items listed in Table 3 can be transmitted in a newly defined frame, element, field, or subfield.

At operation 720, AP 710 can transmit a response frame. That is, when the AP 710 receives the request from STA 705, the AP 710 can determine whether to accept or reject the request. In at least one embodiment, the AP 710 can transmit the response to include the indication of whether the AP 710 accepts or rejects the request. In one embodiment, the AP 710 can accept the request and transmit the acceptance in the response during operation 720. In one embodiment, the response at operation 720 can include at least one or more of the following information items: TXOP reduction acceptance indication (e.g., indicating whether the AP 710 accepts the request, rejects the request, or delays the request, the indication carried as a bit or flag in some embodiments and implicitly implied by the response in other embodiments), a traffic type, a reduction duration, or a reduction period.

At operation 725, the AP 710 can reduce the TXOP limit for downlink transmissions. In at least one embodiment, the AP 710 can reduce a TXOP limit for the STA 705 via an EDCA parameter set element (e.g., for legacy devices). In other embodiments, the AP 710 can reduce the TXOP limit for the STA 705 via an additional UHR EDCA parameter set element that carries the TXOP limit value (e.g., for non-legacy devices, including 802.11be devices). In one embodiment, the AP 710 can reduce the TXOP limit for all devices in the network. In other embodiments, the AP 710 can reduce the TXOP limit for the STA 705.

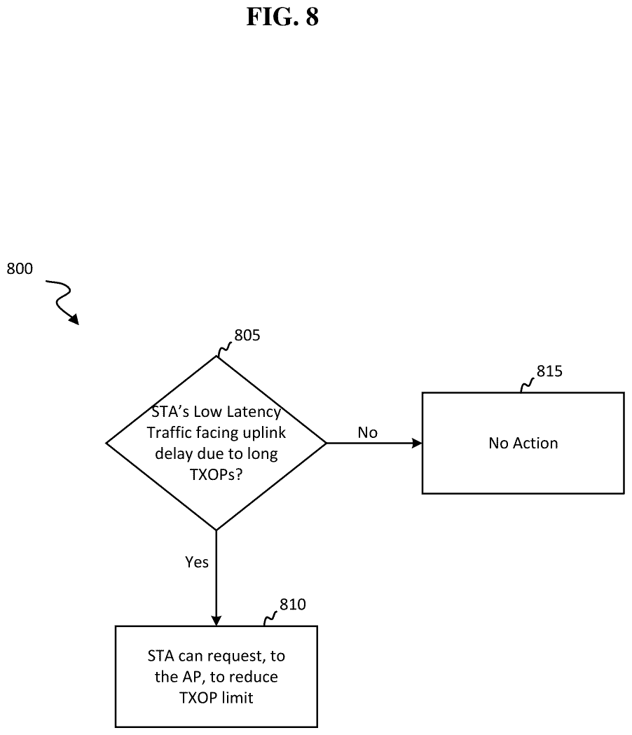

FIG. 8 an example process 800 for TXOP reduction according to an embodiment herein. Although one or more operations are described or shown in a particular sequential order, in other embodiments the operations may be rearranged in a different order, which may include performance of multiple operations in at least partially overlapping time periods. In at least one embodiment, process 800 is performed by a station (STA) (e.g., an example of STA 111, STA 112, STA 113, or STA 114 as described with reference to FIG. 1).

At operation 805, an STA can determine if the STA's low latency (LL) traffic is facing uplink delay due to long TXOPs. In at least one embodiment, the STA can determine if the LL traffic is facing delay based on a predetermined threshold value—e.g., a predetermined threshold value corresponding to a number of failed packet transmissions, a duration in which the STA waits before initiating the request, etc. In one embodiment, the STA determines the LL traffic is facing uplink delay due to long TXOP and proceeds to operation 810. In other embodiments, the STA determines the LL traffic is not facing uplink delay due to long TXOP and proceeds to operation 815.

At operation 810, the STA can request, to the AP, to reduce the TXOP limit. In one embodiment, the STA can transmit a request frame to indicate the request to reduce the TXOP limit. In one embodiment, the STA can transmit a request frame as described with reference to FIG. 7—e.g., a request frame including one or more information items of Table 3.

At operation 815, the STA can refrain from taking any action—e.g., the STA can take no action. That is, because the STA determines the LL traffic is not affected by the long TXOP, the STA can proceed with normal operations.

Although FIG. 8 discusses the STA's LL traffic facing uplink delay, a similar or same process is also applicable to the STA's LL traffic facing downlink delay—e.g., the STA can request a TXOP reduction for uplink or downlink traffic and the AP can accordingly limit the uplink or downlink TXOP limits. In such embodiments, the STA can first determine if the STA's LL traffic is facing downlink delay due to long TXOP. If the STA determines the STA's LL traffic is facing downlink delay, the STA can proceed to operation 810 (e.g., transmit a request to the AP to reduce downlink TXOP limits). In other embodiments, if the STA determines the STA's LL traffic is not facing downlink delay, the STA can proceed to operation 815—e.g., the STA can take no action.

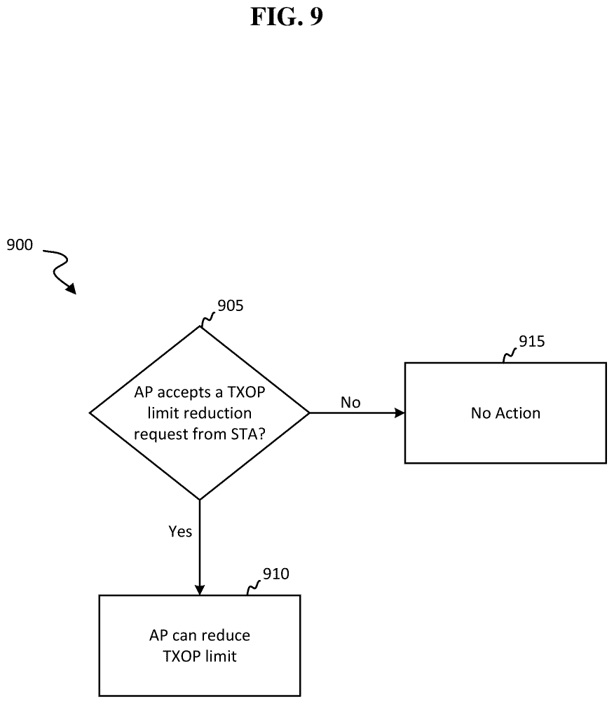

FIG. 9 shows an example process 900 for TXOP reduction according to an embodiment herein. Although one or more operations are described or shown in a particular sequential order, in other embodiments the operations may be rearranged in a different order, which may include performance of multiple operations in at least partially overlapping time periods. In at least one embodiment, process 900 is performed by an access point (AP) (e.g., an example of AP 101 or AP 103 as described with reference to FIG. 1).

At operation 905, an access point (AP) determines whether to accept a TXOP limit reduction request from an associated STA. In at least one embodiment, the AP can receive a request as described with reference to FIG. 7 (e.g., a request including one or more information items of Table 3). In some embodiments, the AP can determine whether to accept or reject the request based on a predetermined threshold value—e.g., a predetermined threshold value corresponding to a number of failed packet transmissions, a duration in which the STA waits before initiating the request, etc. In some embodiments, the AP can determine to accept the TXOP limit request and proceeds to operation 910. In other embodiments, the AP can determine to reject the TXOP limit request and proceed to operation 915.

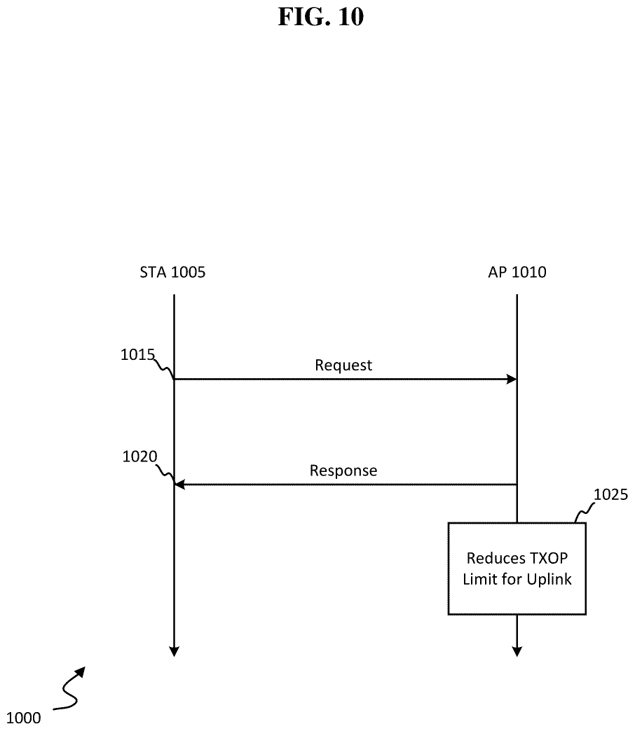

At operation 910, the AP can reduce the TXOP limit. In at least one embodiment, the AP can reduce the uplink transmission TXOP or the downlink TXOP. In at least one embodiment, the AP can reduce the TXOP limit as described with reference to operations 725 and 1025 of FIGS. 7 and 10, respectively. In at least one embodiment, the AP can also transmit a response to the STA indicating the AP has accepted the request, before the AP reduces the TXOP limit.

At operation 915, the AP can refrain from taking any action—e.g., the AP can take no action. That is, because the AP determines the LL traffic is not affected by the long TXOP, the AP can reject the request and proceed with normal operations. In at least one embodiment, the AP can transmit a response to the STA indicating the AP rejects the request, before the AP takes no additional actions.

FIG. 10 shows an example transmission opportunity (TXOP) request process 1000 in accordance with an embodiment. Although one or more operations are described or shown in a particular sequential order, in other embodiments the operations may be rearranged in a different order, which may include performance of multiple operations in at least partially overlapping time periods.

In at least one embodiment, process 1000 is performed by a station (STA) 1005 and an access point (AP) 1010 (e.g., examples of STA 111, STA 112, STA 113, or STA 114 or AP 101 or AP 102 as described with reference to FIG. 1, respectively).

In at least one embodiment, FIG. 10 illustrates a process similar to process 700 but for uplink traffic instead of downlink traffic. For example, at operation 1015, the STA can transmit a request frame. In one embodiment, the STA can transmit the request frame to indicate a request to reduce a TXOP limit (e.g., for an AC) for uplink traffic. That is, if the STA determines that the STA's low latency (LL) traffic encounters a long delay due to large TXOP values, the STA transmits the request in operation 1015. In at least one embodiment, the request frame can include at least one or more of the information items indicated in Table 3 above.

At operation 1020, the AP 1010 can transmit a response frame. That is, when the AP 1010 receives the request from STA 1005, the AP 1010 can determine whether to accept or reject the request. In at least one embodiment, the AP 1010 can transmit the response to include the indication of whether the AP 1010 accepts or rejects the request. In one embodiment, the AP 1010 can accept the request and transmit the acceptance in the response during operation 1020. In one embodiment, the response at operation 1020 can include at least one or more of the following information items: TXOP reduction acceptance indication (e.g., indicating whether the AP 1010 accepts the request, rejects the request, or delays the request, the indication carried as a bit or flag in some embodiments and implicitly implied by the response in other embodiments), a traffic type, a reduction duration, or a reduction period.

At operation 1025, the AP 710 can reduce the TXOP limit for uplink transmissions. In at least one embodiment, the AP 1025 can reduce a TXOP limit for the STA 1005 via an EDCA parameter set element (e.g., for legacy devices). In other embodiments, the AP 1010 can reduce the TXOP limit for the STA 1005 via an additional UHR EDCA parameter set element that carries the TXOP limit value (e.g., for non-legacy devices, including 802.11be devices). In one embodiment, the AP 1010 can reduce the TXOP limit for all devices in the network. In other embodiments, the AP 1010 can reduce the TXOP limit for the STA 1005. In at least one embodiment, the AP 1010 can reduce the TXOP limit for uplink transmission from other STAs in the network. For example, the AP 1010 can adjust the TXOP limit value in the EDCA parameter set element carried in beacon frames, probe response frames, etc. In at least one embodiment, this can indicate to other STAs in the network to reduce their TXOP limit for uplink transmissions.

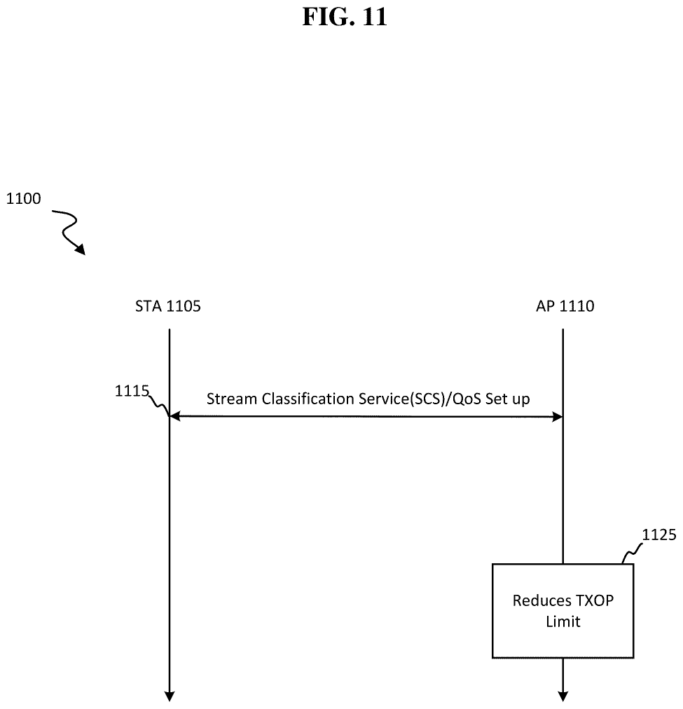

FIG. 11 shows an example transmission opportunity (TXOP) reduction process 1100 in accordance with an embodiment. Although one or more operations are described or shown in a particular sequential order, in other embodiments the operations may be rearranged in a different order, which may include performance of multiple operations in at least partially overlapping time periods.

In at least one embodiment, process 1100 is performed by a station (STA) 1105 and an access point (AP) 1110 (e.g., examples of STA 111, STA 112, STA 113, or STA 114 or AP 101 or AP 102 as described with reference to FIG. 1, respectively).

At operation 1115, the STA 1105 can transmit a quality of service (QoS) characteristic element during a stream classification service (SCS) set up. In some embodiments, during operation 1115, the STA 1105 and AP 1110 can exchange information for the SCS set up. In one embodiment, the AP 1110 can determine a delay requirement of the STA 1105 and a TXOP limit during the SCS set up. In such embodiments, the AP 1110 can proceed to operation 1125 if the AP 1110 determines a need to reduce the TXOP limit—e.g., if the AP 1110 determines the current channel access duration is not enough to meet the delay requirements of the STA 1105 and a duration of the TXOP limit is a contribution for not meeting the delay requirements of the STA 1105, the AP 1110 can proceed to operation 1125.

At operation 1125, the AP 1110 can reduce the TXOP limit. In some embodiments, the AP 1110 reduce the TXOP limit via EDCA parameters set elements—e.g., for legacy devices or a UHR EDCA parameter set element that carries the TXOP limit for non-legacy devices. In some embodiments, the AP 1110 can reduce the TXOP limit for all of the devices in the network. In other embodiments, the AP 1110 can reduce the TXOP limit for the STA 1105.

In at least one embodiment, the STA 1105 can transmit a TXOP limit request for multi-link operations as well. That is, the STA 1105 can transmit a request to reduce the TXOP limit of one link by transmitting a request message on another link. In such embodiments, the request message can carry an indication of which link the STA 1105 wants the TXOP limit to be reduced for.

In one embodiment, the AP 1110 that is capable of making a TXOP adjustment can advertise the AP's 1110 capability in one or more frames the AP 1110 transmits. For example, the AP 1110 can transmit the capability in a beacon frame. In some embodiments, the AP 1110 transmits a frame that includes a field or bit associated with the capability that can be set to a value to indicate whether the AP 1110 supports the capability of reducing the TXOP limit. For example, the AP 1110 can transmit a frame with a capability bit set to one ‘1’ to indicate the AP can perform TXOP limit adjustments and set to zero ‘0’ to indicate the AP cannot perform the TXOP limit adjustment.

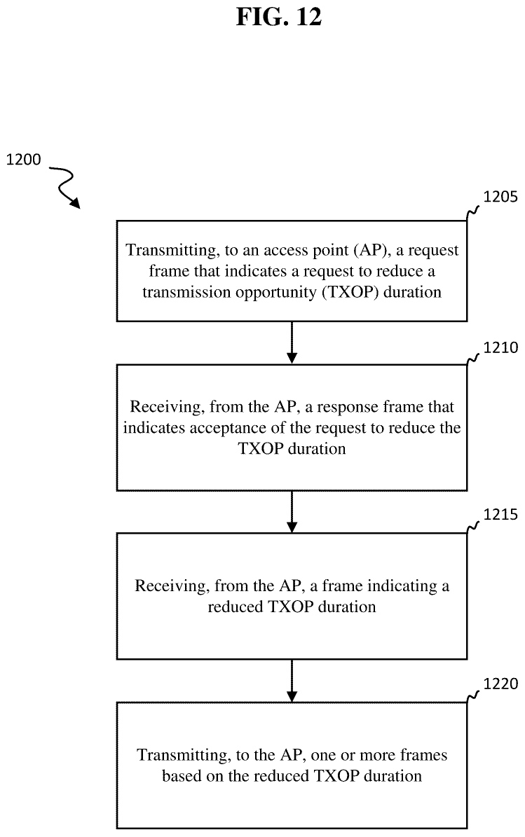

FIG. 12 shows an example process 1200 for a TXOP limit reduction in accordance with an embodiment. For explanatory and illustration purposes, the process 1200 may be performed by an access point (AP) (e.g., AP 710 as described with reference to FIG. 7) and a station (STA) (E.g., STA 705 as described with reference to FIG. 7). Although one or more operations are described or shown in a particular sequential order, in other embodiments the operations may be rearranged in a different order, which may include performance of multiple operations in at least partially overlapping time periods.

Referring to FIG. 12, the process 1200 may begin in operation 1205. At operation 1205, a station (STA) can cause transmitting, to an access point (AP), a request frame that indicates a request to reduce a transmission opportunity. That is, as described with reference to FIG. 7, in some embodiments, the STA can transmit a request to reduce the TXOP when the STA's low latency (LL) packets encounter a long defer delay due to large TXOP values. In some embodiments, the request frame can include contents of Table 3 described above. For example, the request frame can include an indication of a type of traffic associated with the reduced TXOP duration, the request frame indicates an amount by which the TXOP duration is to be reduced, or the request frame indicate a time period during which the TXOP duration is to be reduced.

At operation 1210, the STA can cause receiving, from the AP, a response frame that indicates acceptance of the request to reduce the TXOP duration. In some embodiments, the AP can transmit a response frame to indicate rejection of the request to reduce the TXOP duration and maintain a current TXOP duration.

At operation 1215, the STA can cause receiving, from the AP, a frame indicating a reduced TXOP duration. In some embodiments, the frame indicating the reduced TXOP duration includes enhanced distribution channel access (EDCA) parameters associated with the reduced TXOP duration. In some embodiments, the AP can reduce the TXOP limit for all devices. For example, the AP can transmit, to one or more STA associated with the AP, a second frame indicating the reduced TXOP. In other embodiments, the AP can reduce the TXOP limit for a set or subset of devices—e.g., for legacy devices. In such embodiments, the AP can transmit, to a set of one or more STAs associated with the AP, a second frame indicating the reduced TXOP.

At operation 1220, the STA can cause transmitting, to an AP, one or more frames based on the reduced TXOP duration.

In one embodiment, the STA is affiliated with a non-AP STA multi-link device (MLD) including a plurality of STAs. In such embodiments, the request frame is transmitted over a link established between the STA affiliated with the non-AP MLD and the AP affiliated with an AP MLD and the request frame indicates a request to reduce the TXOP duration on a second link established between another STA affiliated with the non-AP MLD and another AP affiliated with the AP MLD. In one embodiment, the request frame indicates the second link on which the TXOP duration is to be reduced.

In at least one embodiment, the STA can cause receiving, from the AP, a second frame indicating that the AP supports a reduction of TXOP duration.

In one embodiment, the AP can cause receiving, from the STA, a quality of service (QoS) characteristic element during a stream classification service (SCS). In such embodiments, the AP can determine a channel access duration of the STA fails to satisfy a channel delay associated with the STA and transmit, to the STA, a second frame indicating a second reduced TXOP duration responsive to determining the channel access duration of the STA fails to satisfy the channel delay.

By enabling the STA to transmit TXOP reduction requests, the AP and STA can coordinate to reduce channel access delays due to long TXOP limits.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
transmitting, to an access point (AP), a request frame that indicates a request to reduce a transmission opportunity (TXOP) duration;
receiving, from the AP, a response frame that indicates acceptance of the request to reduce the TXOP duration;
receiving, from the AP, a frame indicating a reduced TXOP duration; and
transmitting, to the AP, one or more frames based on the reduced TXOP duration.

2. The STA of claim 1, wherein the request frame includes an indication of a type of traffic associated with the reduced TXOP duration.

3. The STA of claim 1, wherein the request frame indicates an amount by which the TXOP duration is to be reduced.

4. The STA of claim 1, wherein the request frame indicates a time period during which the TXOP duration is to be reduced.

5. The STA of claim 1, wherein the frame indicating the reduced TXOP duration includes enhanced distribution channel access (EDCA) parameters associated with the reduced TXOP duration.

6. The STA of claim 1, wherein:
the STA is affiliated with a non-AP STA multi-link device (MLD) comprising a plurality of STAs;
the request frame is transmitted over a first link established between the STA affiliated with the non-AP MLD and the AP affiliated with an AP MLD; and
the request frame indicates a request to reduce the TXOP duration on a second link established between another STA affiliated with the non-AP MLD and another AP affiliated with the AP MLD.

7. The STA of claim 6, wherein the request frame indicates the second link on which the TXOP duration is to be reduced.

8. The STA of claim 1, wherein the processor is further configured to cause:
receiving, from the AP, a second frame indicating that the AP supports a reduction of TXOP duration.

9. An access point (AP) in a wireless network, comprising:
a memory; and
a processor coupled to the memory, the processor configured to cause:
receiving, from a station (STA), a request frame that indicates a request to reduce a transmission opportunity (TXOP) duration;
transmitting, to the STA, a response frame that indicates acceptance of the request to reduce the TXOP duration;
transmitting, to the STA, a frame indicating a reduced TXOP duration; and
receiving, from the STA, one or more frames based on the reduced TXOP duration.

10. The AP of claim 9, wherein the processor is further configured to cause:
receiving, from the STA, a quality of service (QoS) characteristic element during a stream classification service (SCS);
determining a channel access duration of the STA fails to satisfy a channel delay associated with the STA; and
transmitting, to the STA, a second frame indicating a second reduced TXOP duration responsive to determining the channel access duration of the STA fails to satisfy the channel delay.

11. The AP of claim 9, wherein the request frame includes an indication of a type of traffic associated with the reduced TXOP.

12. The AP of claim 9, wherein the processor is further configured to cause:
transmitting, to one or more STA associated with AP, a second frame indicating the reduced TXOP.

13. The AP of claim 9, wherein the processor is further configured to cause:
transmitting, to a set of one or more STA associated with AP, a second frame indicating the reduced TXOP.

14. The AP of claim 9, wherein the processor is further configured to cause:
transmitting, to the STA, a second frame indicating that the AP supports a reduction of TXOP duration.

15. The AP of claim 9, wherein:
the AP is affiliated with an AP multi-link device (MLD) comprising a plurality of APs;
the request frame is transmitted over a first link established between the AP affiliated with the AP MLD and the STA affiliated with a non-AP STA MLD; and
the request frame indicates a request to reduce the TXOP duration on a second link established between another AP affiliated with the AP MLD and another STA affiliated with the non-AP STA MLD.

16. The AP of claim 9, wherein the frame indicating the reduced TXOP duration includes enhanced distribution channel access (EDCA) parameters associated with the reduced TXOP duration.

17. A method performed by a station (STA) in a wireless network, comprising:
transmitting, to an access point (AP), a request frame that indicates a request to reduce a transmission opportunity (TXOP) duration;
receiving, from the AP, a response frame that indicates acceptance of the request to reduce the TXOP duration;
receiving, from the AP, a frame indicating a reduced TXOP duration; and
transmitting, to the AP, one or more frames based on the reduced TXOP duration.

18. The method of claim 17, wherein the request frame includes an indication of a type of traffic associated with the reduced TXOP duration.

19. The method of claim 17, wherein the request frame indicates an amount by which the TXOP duration is to be reduced.

20. The method of claim 17, wherein the request frame indicates a time period during which the TXOP duration is to be reduced.
